(19) United States
(12) Patent Application Publication
(10) Pub. No.: US 2012/0221406 A1
(43) Pub. Date: Aug. 30, 2012

(54) SYSTEM AND METHOD FOR DELIVERING PREFERENCE-BASED CONTENT AND ADVERTISING

(75) Inventors: Douglas Paul Kruhoeffer, Tonka Bay, MN (US); Douglas John Williams, Orono, MN (US); Todd L. Frostad, Chanhassen, MN (US); Erik G. Swenson, Orono, MN (US)

(73) Assignee: Media Logic Gropu, LLC

(21) Appl. No.: 13/394,333

(22) PCT Filed: Sep. 3, 2009
(86) PCT No.: PCT/US09/55830

§ 371 Date: May 17, 2012

Related U.S. Application Data
(60) Provisional application No. 61/094,343, filed on Sep. 4, 2008.

(51) Int. Cl. G06Q 30/02

(52) U.S. Cl. 705/14.41; 705/14.66

(57) ABSTRACT

A method of delivering content and advertisers ems to a viewer, wherein the advertisement are determined by user preferences. The content and advertisements are associated such that a content provider or advertiser can determine statics regarding their content or advertisements. Such statistics can include how many time the contest or ads were viewed, who viewed It, what was the revenue or cost associated with the view, which content was viewed with which ads, and how did the content or advertisement rate.

### TECHNICAL FIELD

The present invention relates generally to the field of electronic information, and more particularly to a system and method of providing content and advertising based on user-stated preferences.

### BACKGROUND

The digital age provides consumers with a vast resource. Consumers can shop on-line, research and view content and commercial information, and communicate via the Internet, wirelessly, or through digital broadcasts. Most public digital content is supported by advertisements, or “ads”. When a consumer, or user, accesses a piece of digital information, typically, some content is provided to the consumer along with some form of advertisement or advertisements. The advertisements may be random, may be automatically selected by the service based on the content the user is viewing, or may be selected by past history of the user. In most cases the advertisements are targeted at the consumer based on some determination about who the consumer is or what the consumer might desire. The same is true for other advertisement-supported content portals, such as broadcast television.

Such methods and systems have disadvantages. One such disadvantage is consumers do not get the information or advertisements they desire. Another such disadvantage is that advertisers do not get adequate feedback or reporting of how effective their advertisements are. Another disadvantage is that advertisers may not get their ads to the users who want them. One of the most fundamental disadvantages is that consumers do not get the ads that they specifically want or are interested in. Therefore, improvements are desirable.

### SUMMARY

In accordance with the present invention, the above and other problems are solved by the following:

The present invention provides a method of providing web or broadcast based content supported by advertising wherein the consumer not only selects the content to be viewed but also chooses the advertising to support the content by setting previously expressed and changeable preferences or choices or by specifically choosing ads from a menu provided to the consumer which are of interest or relevant to the consumer. The present invention presents a marked departure from the traditional manner in which all advertising has been done. No longer must the consumer get only the ads that the advertisers “think” or “deduce” they want based upon residential data, past purchasing history or the like. But, the present invention provides the consumer with the ability to specifically select individual ads from an offering of the consumers preferred ads.

In one aspect of the present invention, a method of providing feedback regarding advertising is disclosed. The method includes loading content into a viewer for display to a user; determining at least one advertisement from user stated preferences and/or choices; associating the advertisement to the content; loading the advertisement into the viewer for display to the user; determining performance data based on the content and associated advertisement; and providing feedback regarding the performance data. It can be determined how many times the advertisement was viewed, who viewed it, a cost for the advertisement, what content was viewed along with the advertisement, or how was the advertisement received by users.

In another aspect of the present invention, a method of providing feedback regarding how content is disclosed. The method includes loading content into a viewer for display to a user; determining at least one advertisement from user stated preferences; associating the advertisement to the content; loading the advertisement into the viewer for display to the user; determining performance data based on the content and associated advertisement; and providing feedback regarding the performance data. It can be determined how many times the content was viewed, who viewed it, how much revenue was generated, what advertisements were viewed along with the content, or how was the content received by users.

In yet another aspect of the present invention, a method of providing feedback regarding advertising on a client computing device having a processor and a memory is disclosed. The method includes loading content into the client computer memory for display to a user based on a selection by the user; searching for advertising options to display with the content; loading user-stated preferences; filtering the advertising options for advertising options matching the user-stated preferences; filtering the advertising options matching the user-stated preferences for advertising options matching advertising provider preferences; selecting at least one of the advertising options matching advertising provider preferences; loading the selected advertising option into the client computer memory for display to the user; associating the advertising option to the content; determining performance data based on the content and associated ad; and providing feedback regarding the performance data. It can be determined how many times the ad was viewed, who viewed it, a cost for the ad, what content was viewed along with the ad, or how was the ad received by users.

The invention may be implemented as a computer process, a computing system, or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its scope may be obtained from the accompanying drawings, which are briefly described below, from the following detailed descriptions of presently preferred embodiments of the invention and from the appended claims.

### BRIEF DESCRIPTION OF THE DRAWINGS

Referring now to the drawings in which like reference numbers represent corresponding parts throughout:

FIG. 1 is an exemplary embodiment of a schematic representation of methods and systems for determining performance data according to the present disclosure;

FIG. 2 is an exemplary embodiment of a schematic representation of a computing system that may be used to implement aspects of the present disclosure;

FIG. 3 is an exemplary embodiment of a schematic representation for implementing commercial information delivery according to the present disclosure;

FIG. 4 is an exemplary embodiment of a schematic representation of types of data according to the present disclosure;

FIG. 5 is an exemplary embodiment of a process flow diagram illustrating a method for managing a user account according to the present disclosure;

FIG. 6 is an exemplary embodiment of a schematic representation of types of user selections according to the present disclosure;

FIG. 7 is an exemplary embodiment of a schematic representation for implementing commercial information delivery according to the present disclosure;

FIG. 8 is an exemplary embodiment of a process flow diagram illustrating a method of filtering commercial information according to the present disclosure;

FIG. 9 is an exemplary embodiment of a process flow diagram illustrating a method of managing content and commercial information according to the present disclosure;

FIG. 10 is an exemplary embodiment of a content dashboard for viewing content information according to the present disclosure;

FIG. 11 is an exemplary embodiment of a content detail viewer for viewing details about content according to the present disclosure;

FIG. 12 is an exemplary embodiment of upload content viewer for uploading content according to the present disclosure;

FIG. 13 is exemplary embodiment of an ad dashboard for viewing ad information according to the present disclosure;

FIG. 14 is an exemplary embodiment of an ad detail viewer for viewing details about an ad according to the present disclosure;

FIG. 15 is an exemplary embodiment of an upload ad viewer for uploading ads according to the present disclosure;

FIG. 16 is an exemplary embodiment of a demographics viewer for viewing demographics associated with content or ads according to the present disclosure;

FIG. 17 is an exemplary embodiment of an associated viewer for viewing content associated with an ad according to the present disclosure;

FIG. 18 is an exemplary embodiment of an aggregate viewer according to the present disclosure;

FIG. 19 is an exemplary embodiment of a profile setup page according to the present disclosure;

FIG. 20 is an exemplary embodiment of a task-focused login according to the present disclosure;

FIG. 21 is an exemplary embodiment of a profile block according to the present disclosure;

FIG. 22 is an exemplary embodiment of a data relationship schema according to the present disclosure;

FIG. 23 is an exemplary embodiment of an ad technology access model illustrating a method of communicating ad content to an external system based on user and content data according to the present disclosure.

### DETAILED DESCRIPTION

Various embodiments presented herein will be described in detail with reference to the drawings, wherein like reference numerals represent like parts and assemblies throughout the several views. Reference to various embodiments should not be construed as limiting the scope of covered subject matter, which is limited only by the scope of the claims attached hereto. Additionally, any examples set forth in this specification are not intended to be limiting and merely set forth some of the many possible embodiments.

In general, the present disclosure relates to determining performance data for associated content and commercial information delivery via any content portal. Content can include any written, video, audio, or other content available, such as articles, television programs, movies, personal video clips, the news, weather, etc. A content portal can include a web viewer via the Internet, software running on a cable box or satellite receiver, software running on a mobile device, or any other portal that allows a user to view content.

In one example of a content portal, a user of the Internet will visit numerous web pages containing content. Most of these web pages will display advertisements along with the content. The advertisements are typically delivered based on targeting certain demographics, or tying the advertisements to some content aimed at delivering advertisements to particular demographics related to the content. In the present disclosure, advertisements are delivered based on user-stated preferences. By the term “user-stated preferences” it is meant that the user determines which ads, the user wishes to view. The user-stated preferences can be previously stated or stated at the time of viewing the ad content. Thus, when the user views the content, the user also views the ads that the user stated he wished to receive.

In general, a user will establish an account prior to viewing content. In establishing the account, the user will state his preferences for commercial information delivery. The user stated preferences may be as simple as “electronic devices” or as detailed as “Sony LCD televisions”. When the user views content, the ads that are delivered to the user will match the user's stated preferences. For example, if the user reads the Wall-Street Journal® on-line, the advertisements that appear within the web page for the Wall Street Journal® will include ads based on the user's stated preferences rather than ads targeted at every other Wall Street Journal® reader. Thus, when the user surfs that website, the user is getting the information he wants, and the advertiser is assured that its advertisement is going to specific users that will read that advertisement. Likewise, if the user were watching a television program, the advertisements that will appear within that television program will include advertisements based on the user's stated preferences rather than advertisements targeted at every other viewer of the television program.

In addition, the advertiser can get feedback about its ad's performance. For example, how many times was my ad viewed by users, who viewed it (certain demographics about the user's that picked that ad can be fed back to the advertiser), what did my ad cost, what content was viewed along with my ad (i.e. it was viewed on the Wall Street Journal® web page or YouTube® during the playing of a certain home movie), or how did my ad rate. Furthermore, the content provider can get feedback about its content's performance. For example, how many times was my content viewed, who viewed it, what revenue was generated based on my content, what ads were viewed along with my content, and how did my content rate.

The present disclosure provides for pre-selected user preferences. The general idea of user preferences is disclosed in patent application 61/073,938, entitled “System and Method for Providing Commercial Information to Location-Aware Devices” filed on Jun. 19, 2008, and patent application 60/938,386, entitled “Interactive Customizable Broadcast” filed on May 16, 2007, and patent application 60/930,637, entitled “Interactive Customizable Broadcast” filed on May 17, 2007, and PCT/US2008/063198, also entitled “Interactive Customizable Broadcast” filed on May 9, 2008, all of which are hereby incorporated by reference in their entirety. The preferences can provide a wide variety of input with respect to the specific likes and dislikes of each individual user relating to a wide array of subject matter. The user can also employ the preferences feature to advise the content provider about categories of advertising that the user is or is not interested in. Similarly, through a series of questions or interactive maps, a user can state geographic preferences for news stories or other featured content.

While a particular content provider is working continuously to supplement and update the vast amount of information available to offer a user, the preferences act as a filter to further refine and limit the offerings that are presented. Another aspect of the present disclosure is a learning feature of the user's stated preferences. That is, the present disclosure employs a web technology that “learns” from the choices made by the user on an ongoing basis and then is able to predict other items that may be of interest to the user. This web technology is similar to that employed by web merchants like Amazon® in learning the purchasing preferences of their customers. Each time a choice is made, the system further learns and refines the user's preferences to permit the content provider to more completely serve the user content and advertising that the user prefers.

The preferences can also include the ability to select all stories or features created by favorite news anchors or reporters or all editorials of a favorite commentator. Similarly, the user can choose to accept all new advertising and press releases from favorite companies that relate to certain products or services. In addition, the learn feature permits the system to learn and predict what stories, features and advertising the user may also wish to choose from and offer these predictive.

A “Related Content” feature can also be an interactive “crawl” that is scrolling constantly to the side of the main viewer player during surfing. The “Related Content” may include both featured content and advertising, as well as links to websites of potential interest to the user. The number of advertising segments required by a content provider can vary as a matter of choice by the content provider. For example, advertising could be required in a ratio of selected featured content to advertising segments.

In current content services there is no known system that permits a user to select only the content of interest to them and to individually select the advertising messages of interest to them. Further, the present disclosure is the only service that will permit feedback to the advertisers as to which content their ads were viewed with or to content providers as to which ads their content was viewed with.

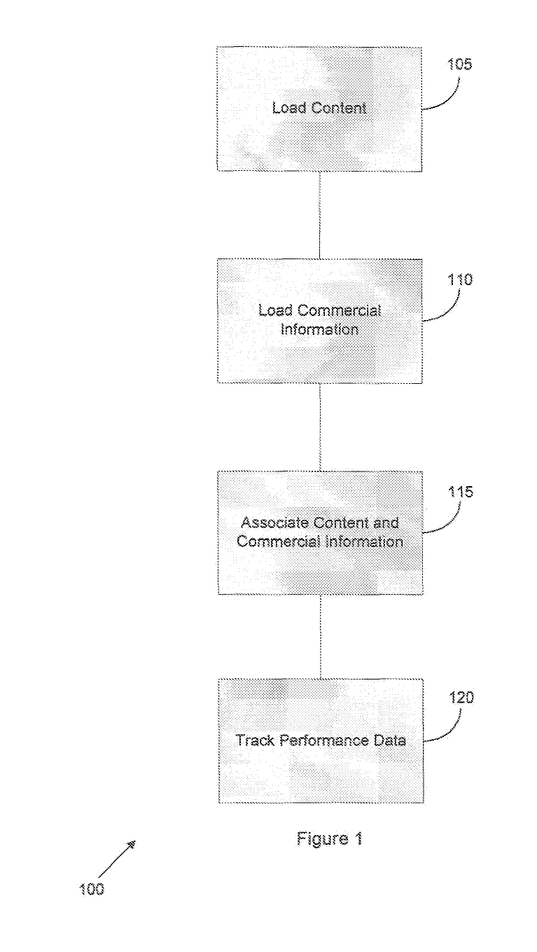

Referring now to the Figures, FIG. 1 depicts a block diagram representing a method and system 100 that provides for providing feedback for commercial information and content. By the term “commercial information” it is meant any electronic information that is related to commercial enterprises. Such information can include, for example, advertisements, product information, product specifications, coupons, rebates, or other information related to commercial enterprises. By the term “content” it is meant any electronic information, and includes, for example, written text, such as articles; video clips, audio clips, or any other information delivery media. A first load module 105 loads the content into a viewer for display to a user. The viewer could be a web viewer, software running on a cable box, or any other viewer.

A second load module 110 loads commercial information into the viewer for display to a user. An associate module 115 associates the content and commercial information to each other. A track module 120 tracks performance data for the content or the commercial information.

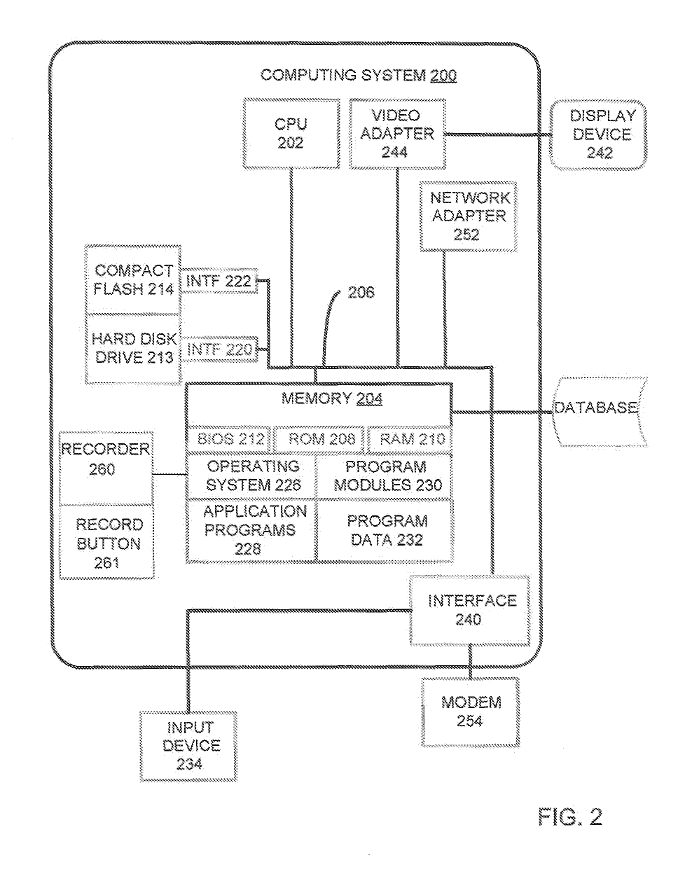

FIG. 2 and the following discussion are intended to provide a brief, general description of a suitable computing environment in which the invention might be implemented. Although not required, the invention is described in the general context of computer-executable instructions, such as program modules, being executed by a computing system. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

Referring now to FIG. 2, an exemplary environment for implementing embodiments of the present invention includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

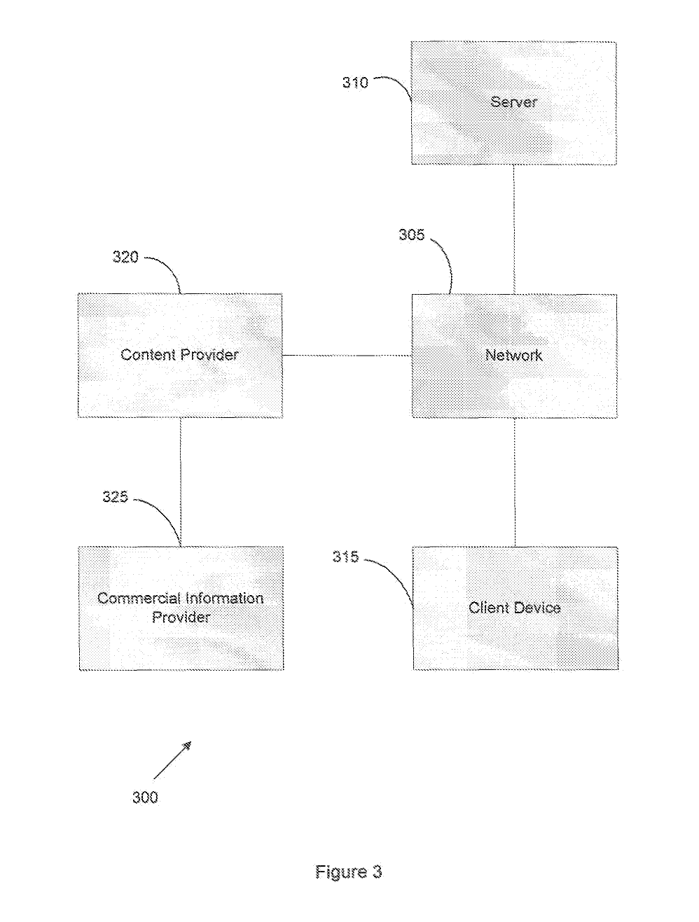

FIG. 3 is a block diagram illustrating an example system 300 for implementing performance tracking. Preferably, the system 300 includes a network 305, at least one server 310, it least one client device 315, at least one content provider device 320, and at least one commercial information provider device 325. Preferably, the server 310 includes a database for storing at least the performance data and client data. The network facilitates communication between the server 310, the client 315, the content provider 320, and the commercial information provider 325. The network 305 could be a LAN, WAN, private, or public network, or could be the World Wide Web or Internet. In an alternative embodiment, this communication could be facilitated on one server. For example, the technology could be installed on a server next to a content provider and thus a network may not be necessary to facilitate communication.

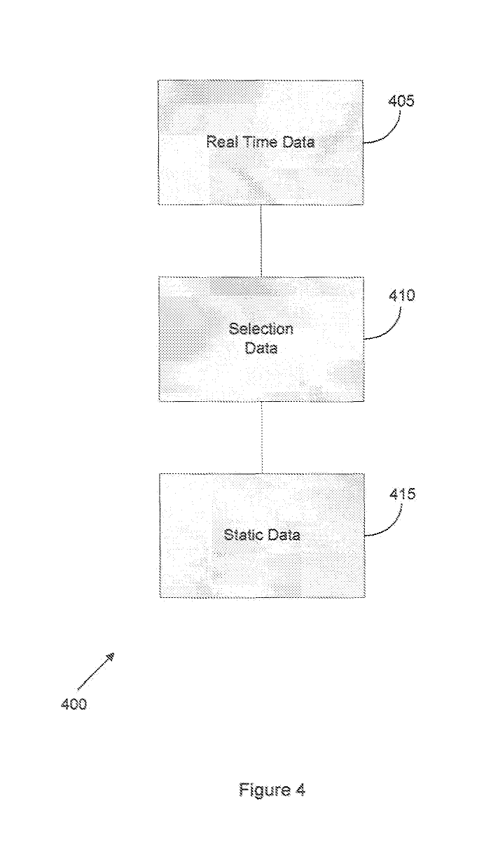

FIG. 4 is a block diagram illustrating different types of data 400 that can be used in the delivery of commercial information. A real time module 405 includes real time data. Such data cat include a device's physical location and the present date and time. A selection module 410 includes selection data. Selection data includes information desired, or selected, by the user. The selection data can be based on selection, or choices, previously made by the user. The user can create a list or hierarchy of its selections that the system can use to determine or filter relevant commercial information for delivery. For example, a user can select local coffee shops. The selection data can include, for example, that a user is interested in electronics, flat-screen LCDs, diapers, baby supplies, cars, furniture, local restaurants, or other information.

A static module 415 includes static information. Static information is typically information that is not constantly changing and can include demographic information about the user, such as the user's age, address, income level, etc. Static information can also be used as a basis for commercial information delivery. For example, advertisers may wish to deliver ads to certain demographic groups. Thus, the static data can be used to determine if a particular user meets that criteria.

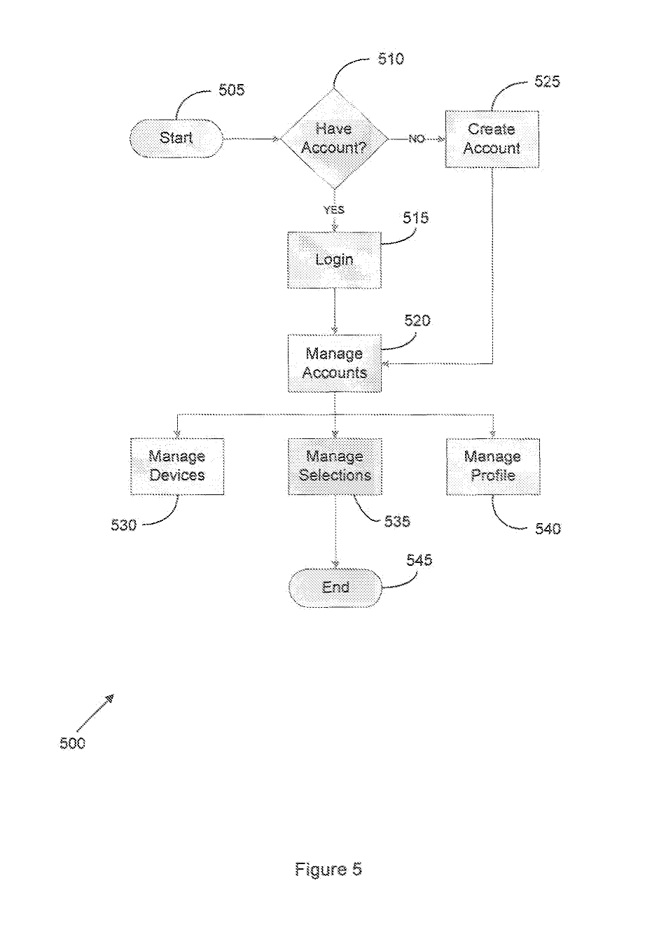

FIG. 5 is an exemplary process flow diagram of a user management system 500 for the user to manage its account. The process flow begins at start 505. An account operation 510 determines if the user has an account. if the account operation 510 determines that the user has an account, operational flow branches “YES” to a login module 515. The login module 515 logs the user into the system 500. A manage account module 520 allows the user to manage his account.

Referring back to the account operation 510, if the account operation 510 determines that the user does not have an account, operational branches “NO” to a create module 525. The create module 525 creates an account for the user. Operational flow continues to the manage account module 520.

Preferably, the manage account module 520 branches into a device module 530, a selection module 535, and a profile module 540. The device module 530 allows a user to manage his devices. A user may have multiple devices under his account. For example, user may have a PDA, a navigational system in his vehicle, and a personal computer at home and work. Under the device module 530, the user can establish which device or devices to include for commercial information delivery. The user initially may list hit; available devices with appropriate network identification. Later the user may enable or disable certain devices depending on his current desires. For example, during the work week, the user may disable his PDA on the network for commercial information delivery. On weekends, the user may enable his PDA on the network to receive certain commercial information.

The selection module 535 allows a user to manage his selections, such as local coffee shops. The selections may be numerous, may be organized graphically, in a list or hierarchy, may be suggested to a user, or otherwise. The profile module 540 allows a user to manage his profile. The profile can include demographic information, account information, family information, or other normal data that remains relatively constant.

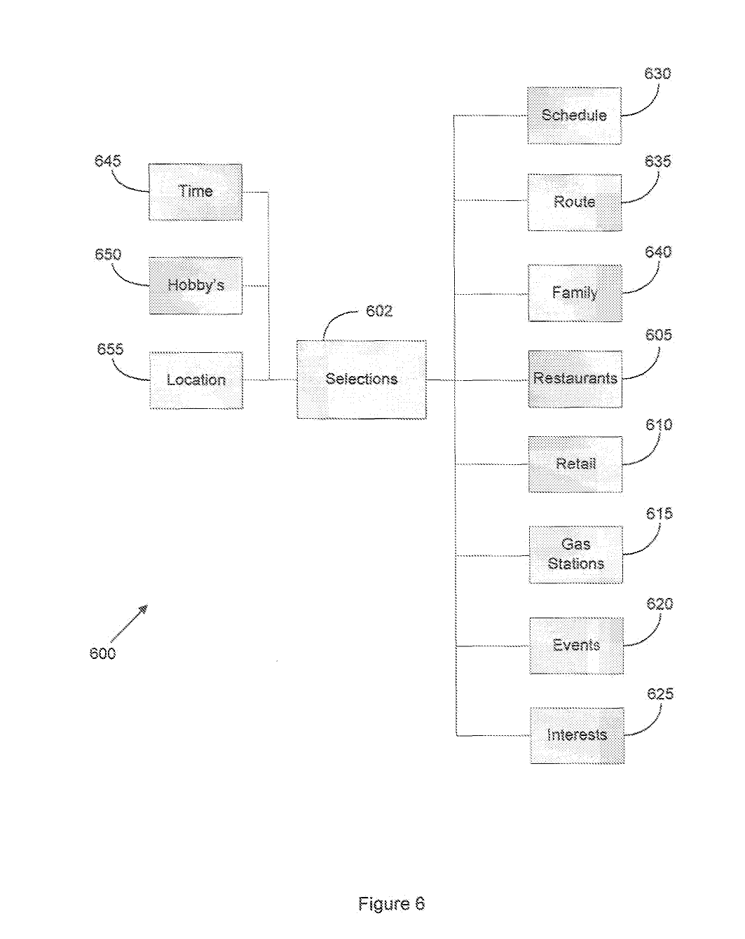

FIG. 6 is a block diagram illustrating an example selection system 600. The selection system 600 includes selections 602 that a user may make. A user may select restaurants 605. Once selected, restaurants could be divided into sub-segments such as type of restaurant, menu choices, coffee shops, whether the restaurant is independent or a chain of restaurants, etc. A user may select retail 610. Once selected, retail could be divided into sub-segments such as home improvement, electronics, commodity goods, baby supplies, groceries, etc. A user may select gas stations 615. Once selected, gas stations could be divided into sub-segments such as by brand, price, or whether it includes a convenience store. The selection system 600 can include numerous layers and sub-layers to drill down to any level of detail. Selections 602 can also include events 620, interests 626, schedule 630, route 635, family 640, time, 645, hobby's 650, and location 655. The selections 602 illustrated are meant to be examples only and are not intended to limit the disclosure.

In addition, a user may input his schedule or the system could be associated with his calendar to associate events to information or allow the user to select certain event triggers that may allow commercial information delivery. For example, a user may desire to receive lots more commercial information delivery to his device while on vacation in an unknown area. In addition, the user may be interested in different types of commercial information while on vacation such as hotels and rental car facilities. Furthermore, a user may input his hobbies or interests that can be used to derive the selections for the user.

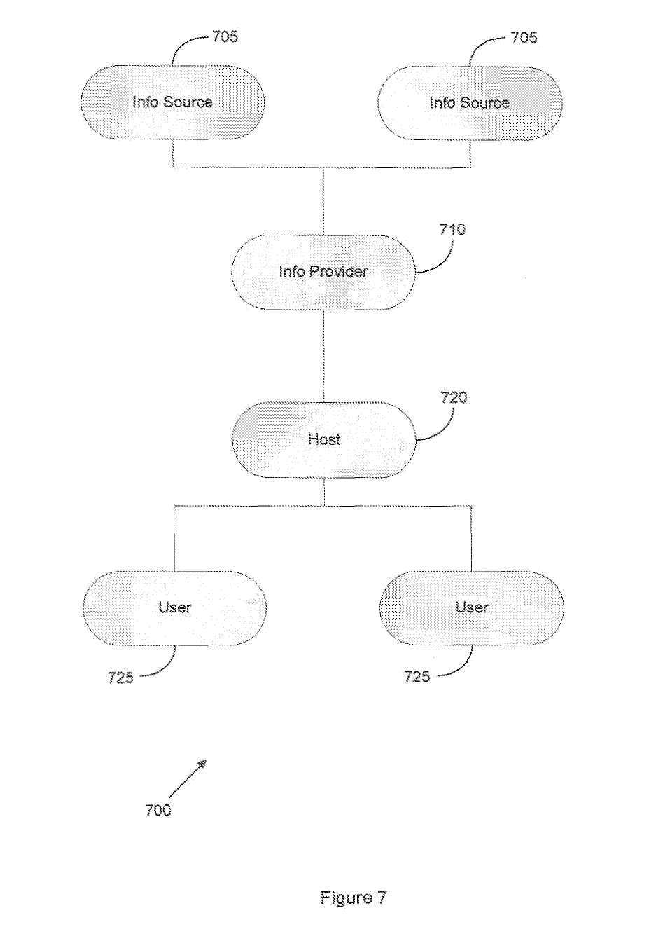

FIG. 7 is an exemplary diagram illustrating a multi-party relationship 700 to facilitate delivery of commercial information. Preferably, the relationship 700 includes at least one information source 705. The information source can be a retailer who desires to advertise to users. The relationship 700 also includes at least one info provider 710. The info provider 710 aggregates the information sources 705. The relationship 700 includes at least one host 720 and at least one user 725. The host 720 delivers commercial information to a user 725.

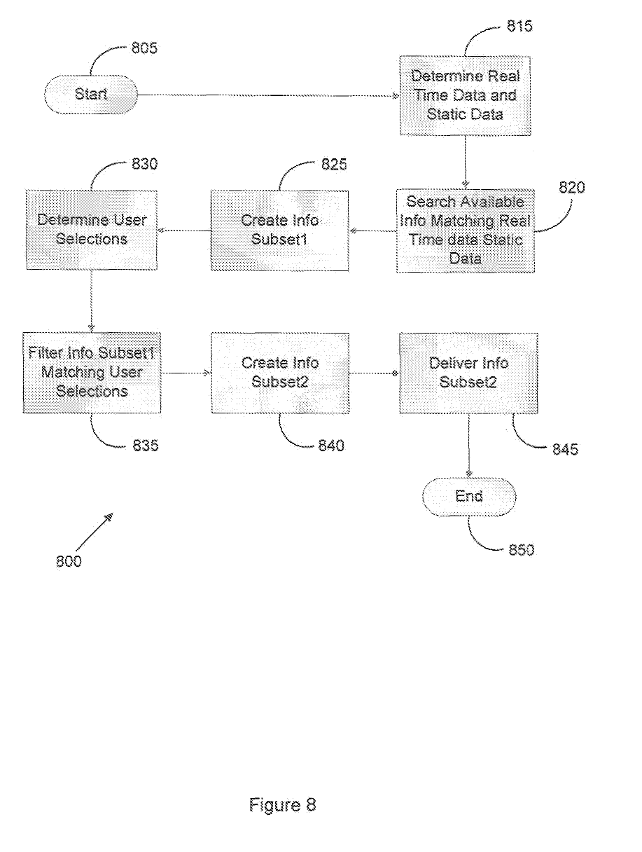

FIG. 8 is an exemplary process flow diagram of methods and systems 800 for delivering commercial information. The flow diagram begins at start 805. A data module 815 determines real-time information, such as the current time and date, and static information, such as the user's age. A search module 820 searches all available information matching the real time data and static data. For example, an advertiser may only wish to advertise during evening hours to people who's ages are between 40-45. A first create module 825 creates a subset1 of information. The subset1 of information includes all commercial information that matches the real time data and static data from the data module 815.

A selection module 830 determines a user's stated selections. A filter module 835 filters the subset1 information that matches the user's stated selections. A second create module 840 creates a subset2 of information. A delivery module 845 delivers the subset2 information to the device. The process flow ends 850.

Likewise, user preferences could be used to narrow content choices. For example, a user may state his preference for weather and local news stories. That content can be presented to the user in a narrowed list of content for the user to choose from. In addition, advertisements could be presented to the user in a narrowed list of advertisements for the user to choose from. The narrowed list may be populated with advertisements that match advertiser provider's preferences, such as demographics.

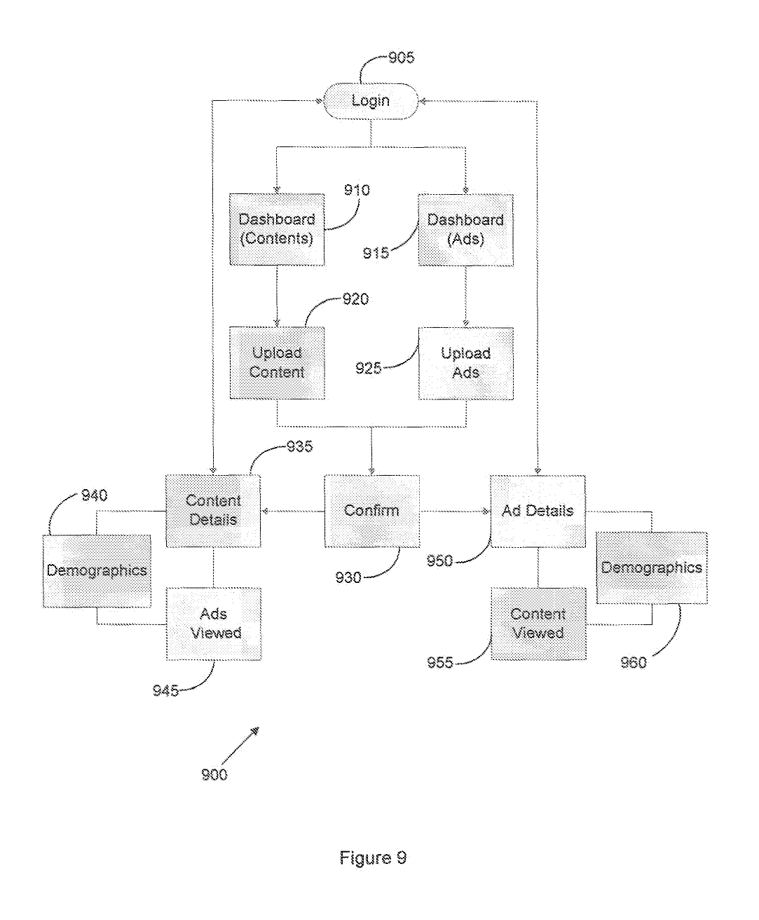

Referring now to FIG. 9, a system 900 for delivering content and ads is illustrated. A login module 905 is provided. A first dashboard module 910 and a second dashboard module 915 are provided for viewing and managing content and ads, respectively. A first upload module 920 and a second upload module 925 are provided for uploading content and ads respectively, A confirm module 930 allows confirmation of the uploads. A content details module 935 allows details about the content to be viewed. A first demographics module 940 allows associated demographics to be viewed. An ad module 945 allows ads associated with the content to be viewed. Likewise, an ad details module 950 allows details about the ads to be viewed. A second demographics module 955 allows associated demographics to be viewed. A content module 960 allows content associated with the ads to be viewed.

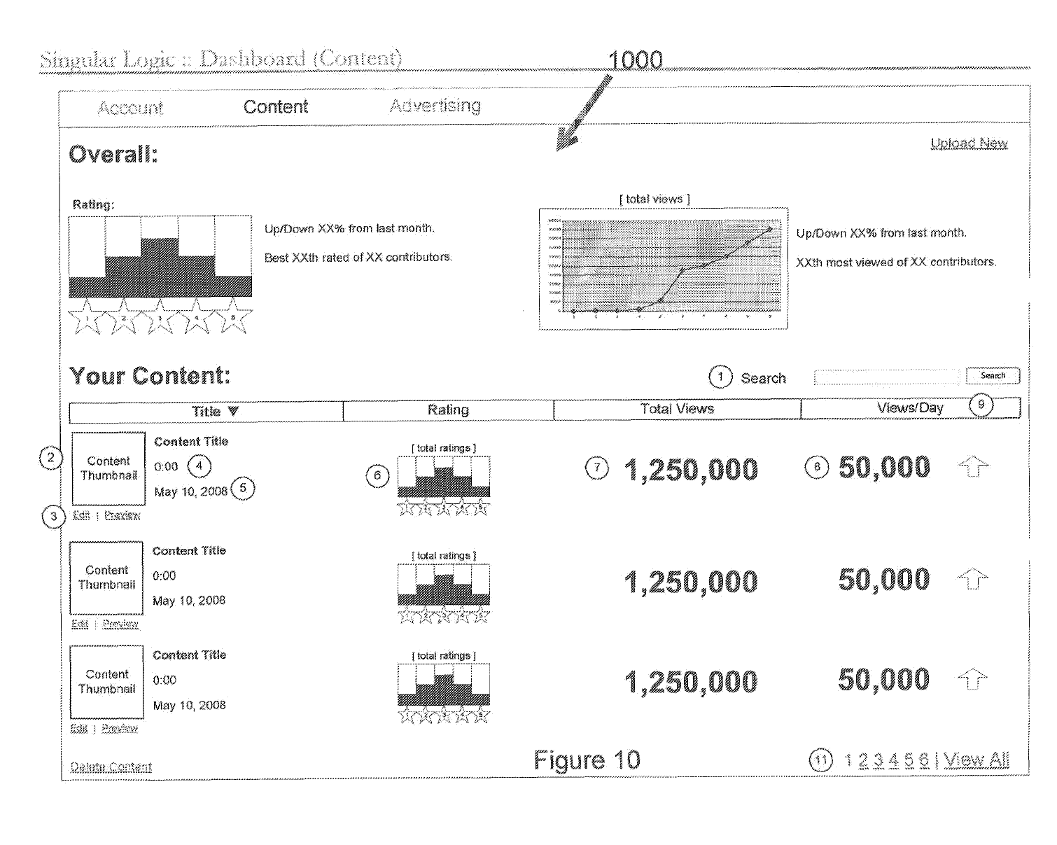

Referring to FIG. 10, an example content dashboard 1000 is illustrated. Information about the content viewed can be ascertained here. For example, the information provided can include the rating, total views, and increase or decrease percentage from last month. Multiple pieces of content can be managed here.

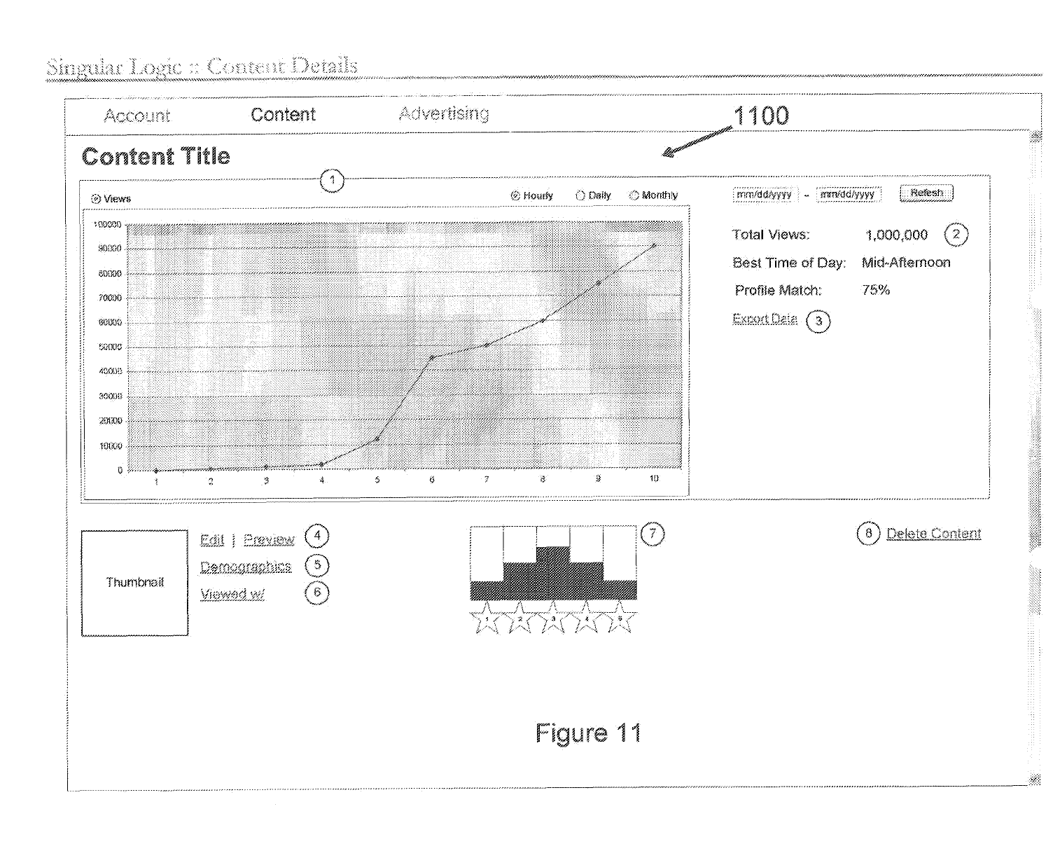

Referring to FIG. 11, an example content details module 1100 is illustrated. This particular view could be ascertained by clicking on an individual piece of content in the dashboard 1000. Here details about the content can be viewed, such as the number of views per hour, day, or month, total cumulative views, best time for viewing, and other information.

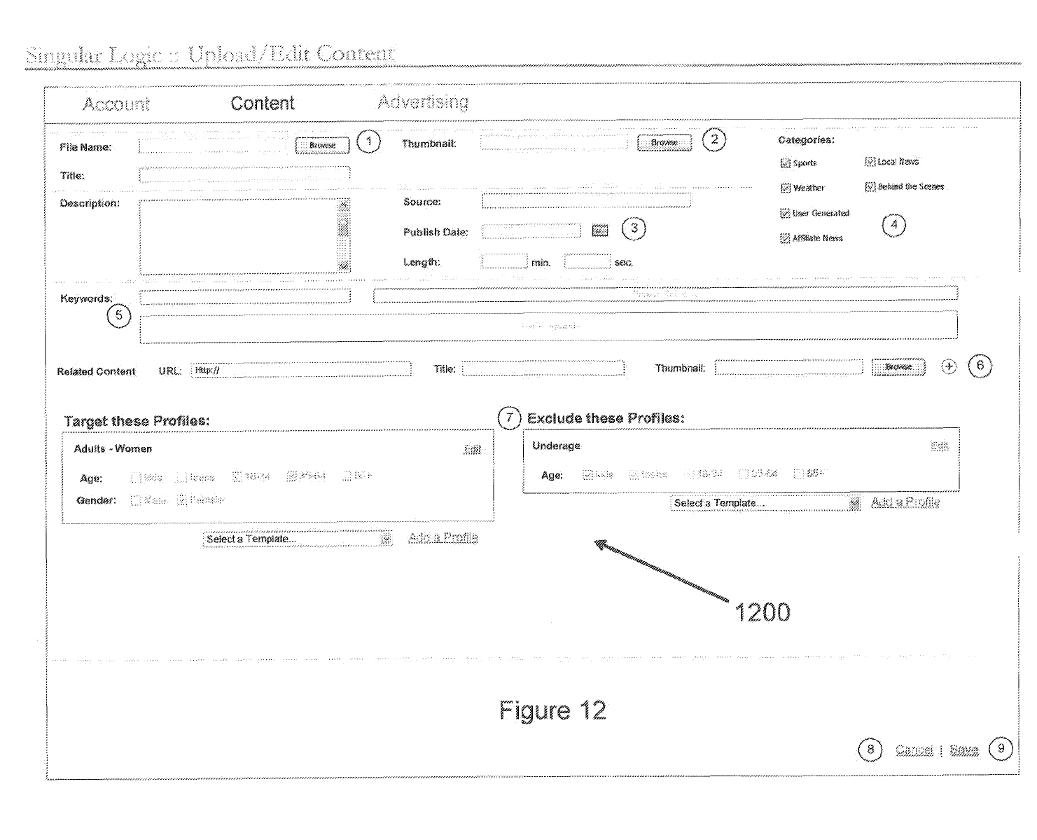

Referring to FIG. 12, an example upload content module 1200 is illustrated. Here the content can be managed. The content can be affiliated with certain categories, targeted to certain profiles or excluded from certain profiles.

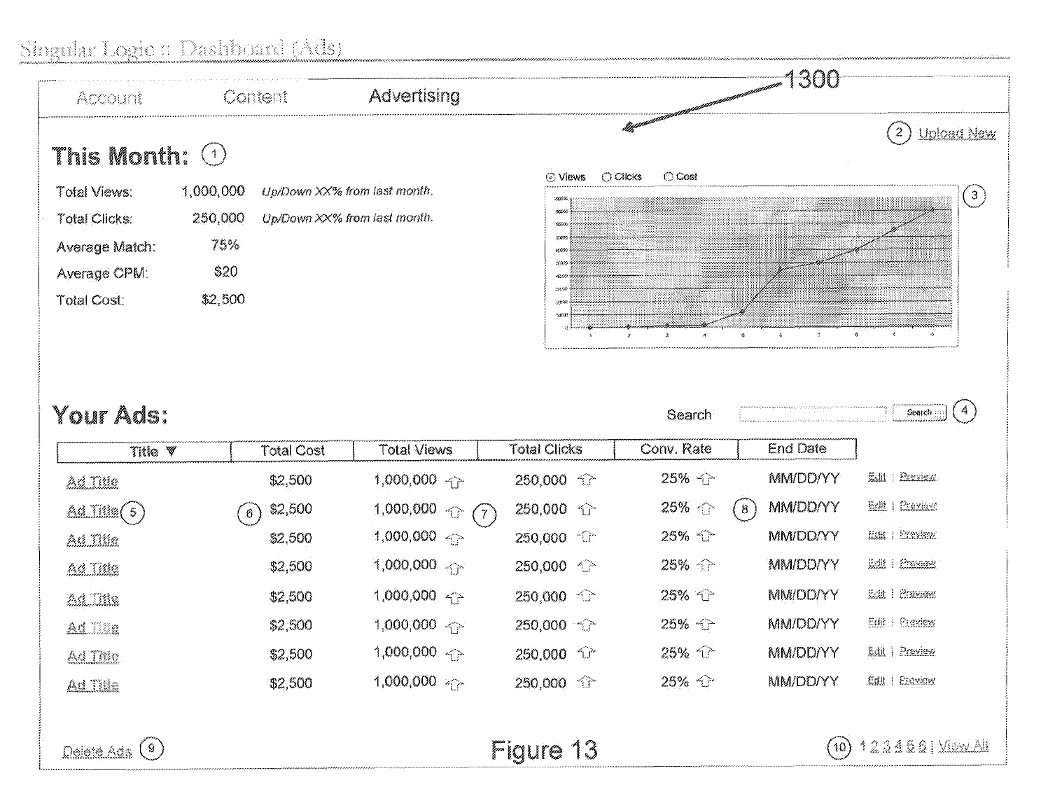

Referring to FIG. 13, an example ad dashboard 1300 is illustrated. Information about the ads viewed can be ascertained here. For example, the information provided can include the total cumulative views, increase or decrease percentage from previous time period, total clicks, average cpm, total cost, conversion rate, and end date.

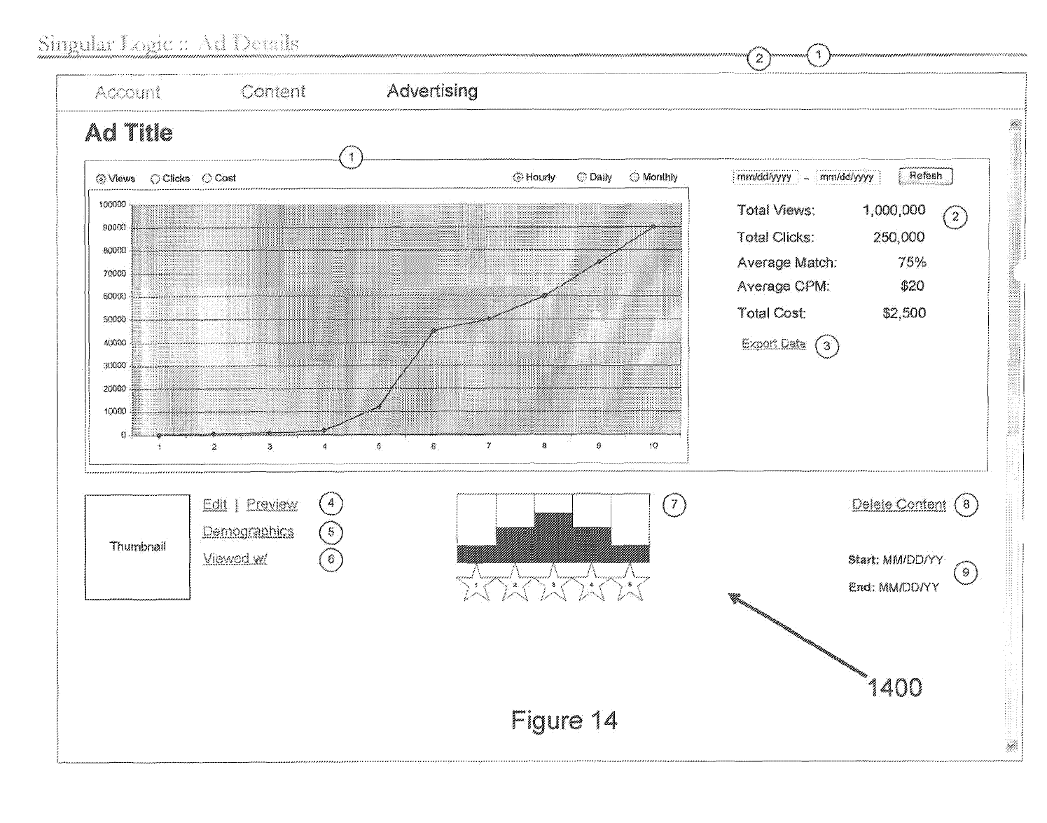

Referring to FIG. 14, an example ad details module 1400 is illustrated. This particular view could be ascertained by clicking on an individual ad in the dashboard 1300. Here details about the ad can be viewed.

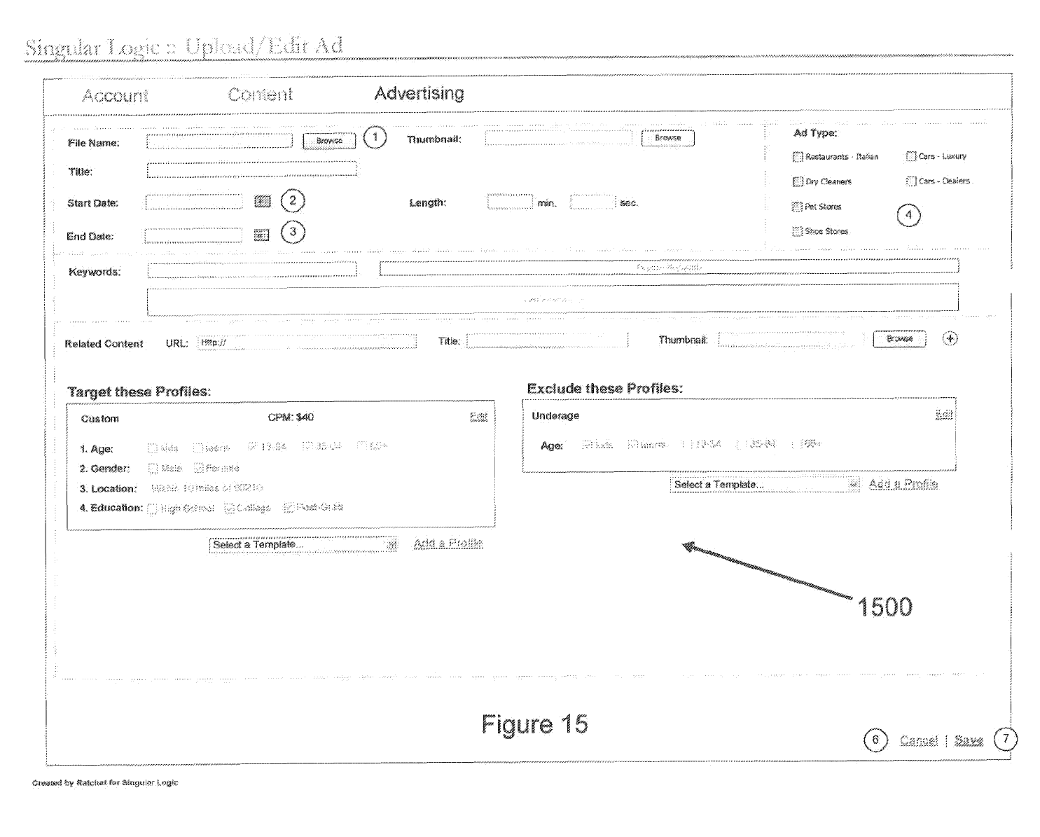

Referring to FIG. 15, an example upload ad module 1500 is illustrated. Here the ad can be managed. The ad can be affiliated with certain categories, targeted to certain profiles or excluded from certain profiles.

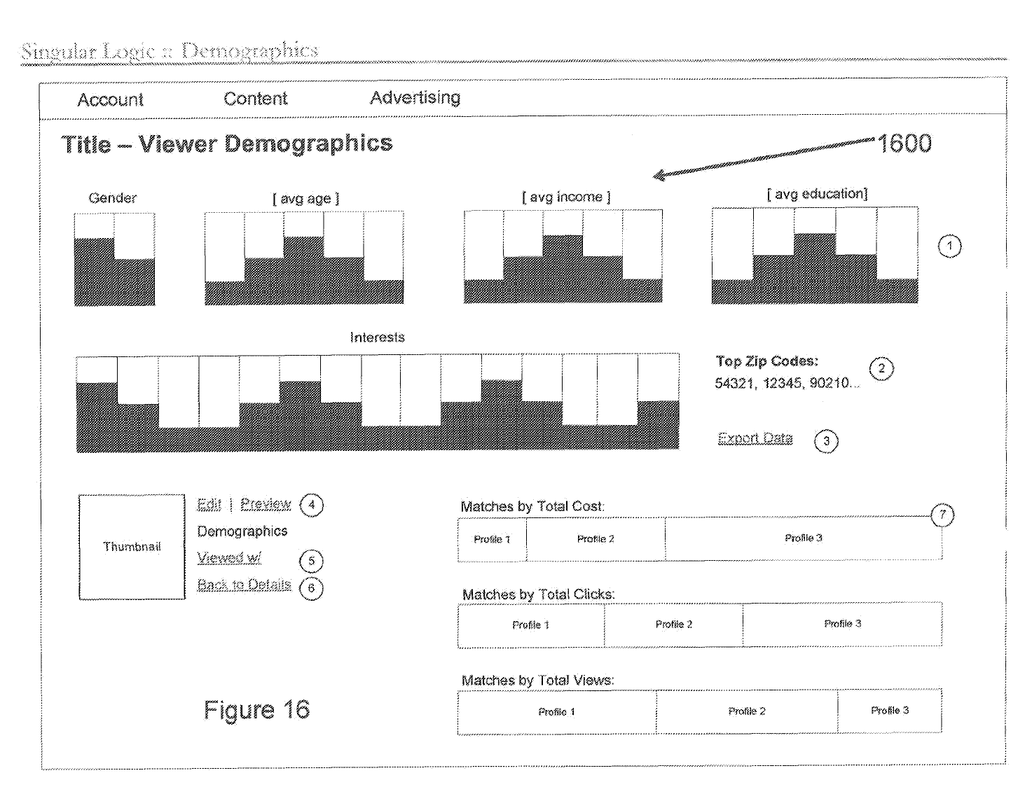

Referring to FIG. 16, an example demographics module 1600 is illustrated. Here particular viewer demographics can be ascertained.

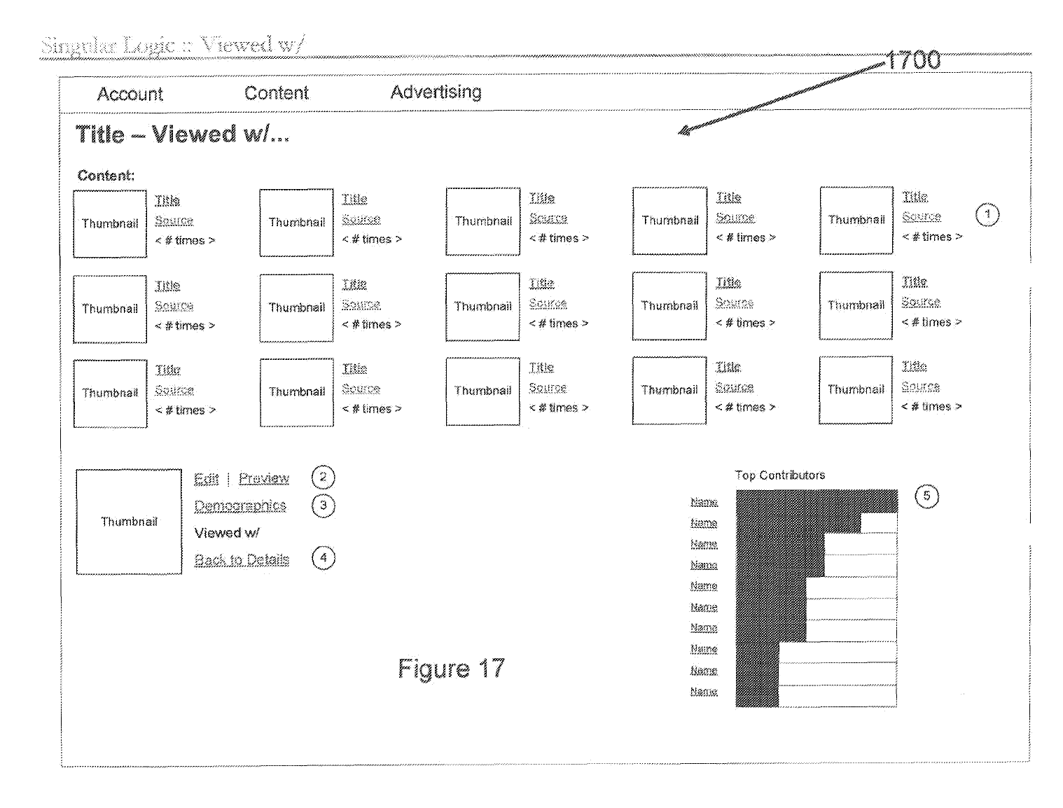

Referring to FIG. 17, an example content viewed module 1700 is illustrated. For a particular ad, the content viewed alongside that ad can be ascertained.

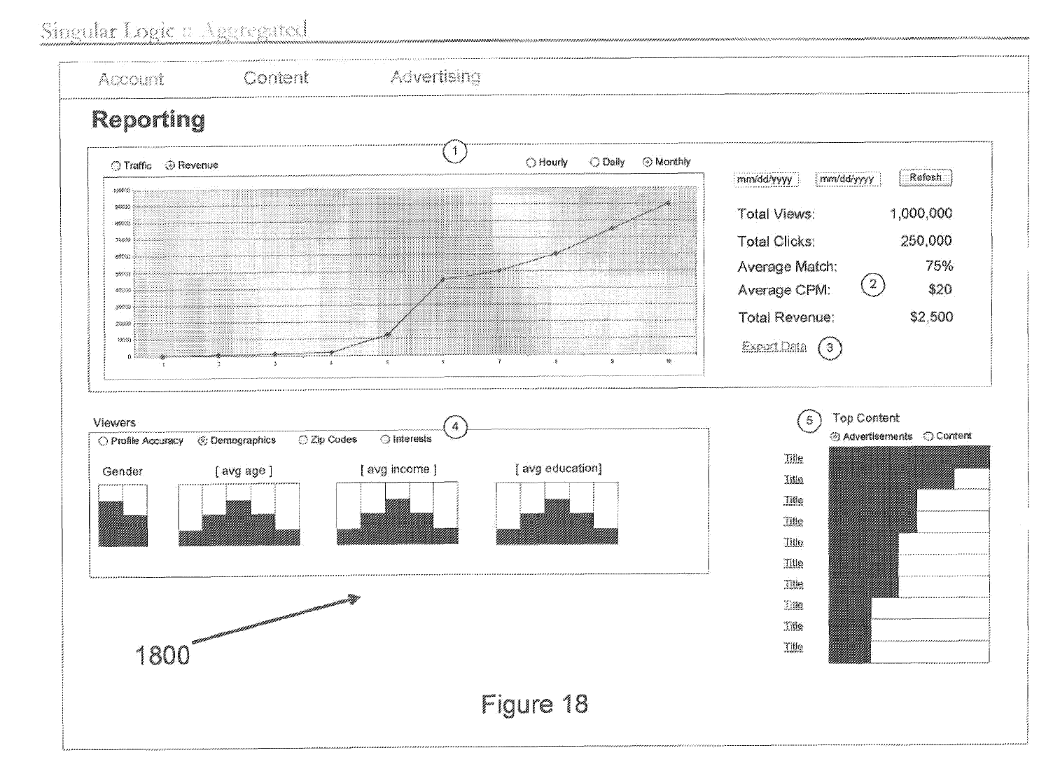

Referring to FIG. 18, an example aggregated view 1800 is illustrated. The aggregated view 1800 demonstrates the performance characteristics and related demographics of the viewership of all content and/or advertisements contained within the system.

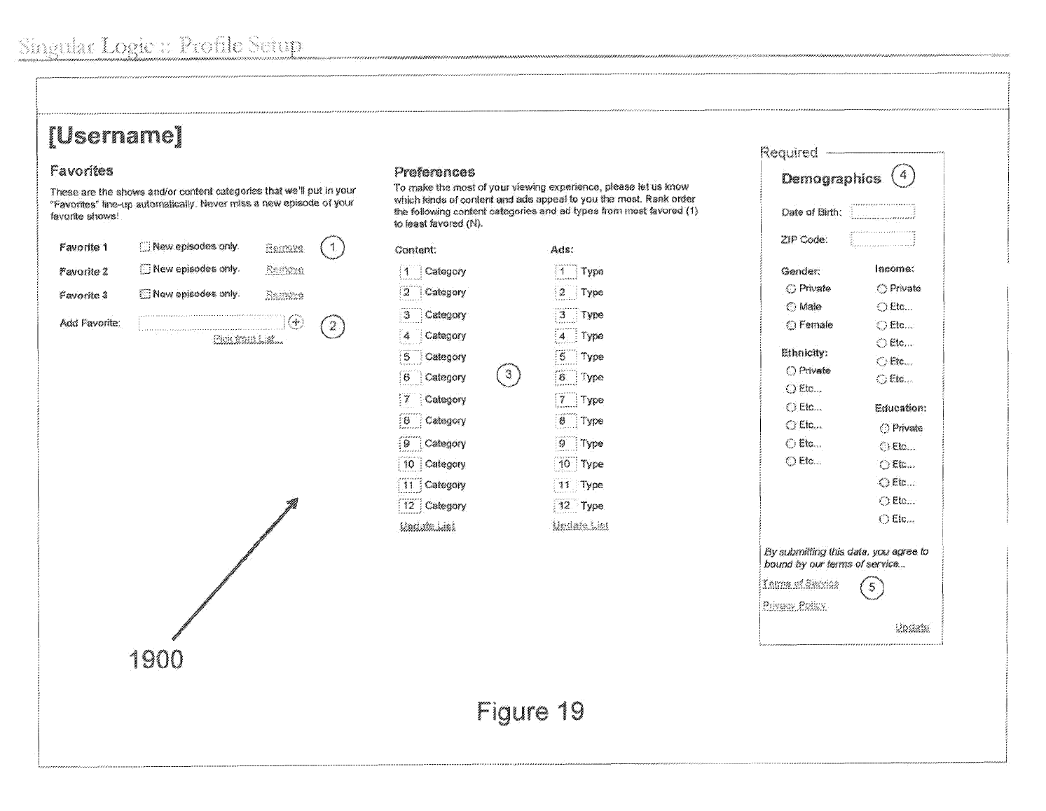

Referring to FIG. 19, an example profile setup 1900 is illustrated. Here a user of the system can identify content preferences, ad preferences, and demographic information.

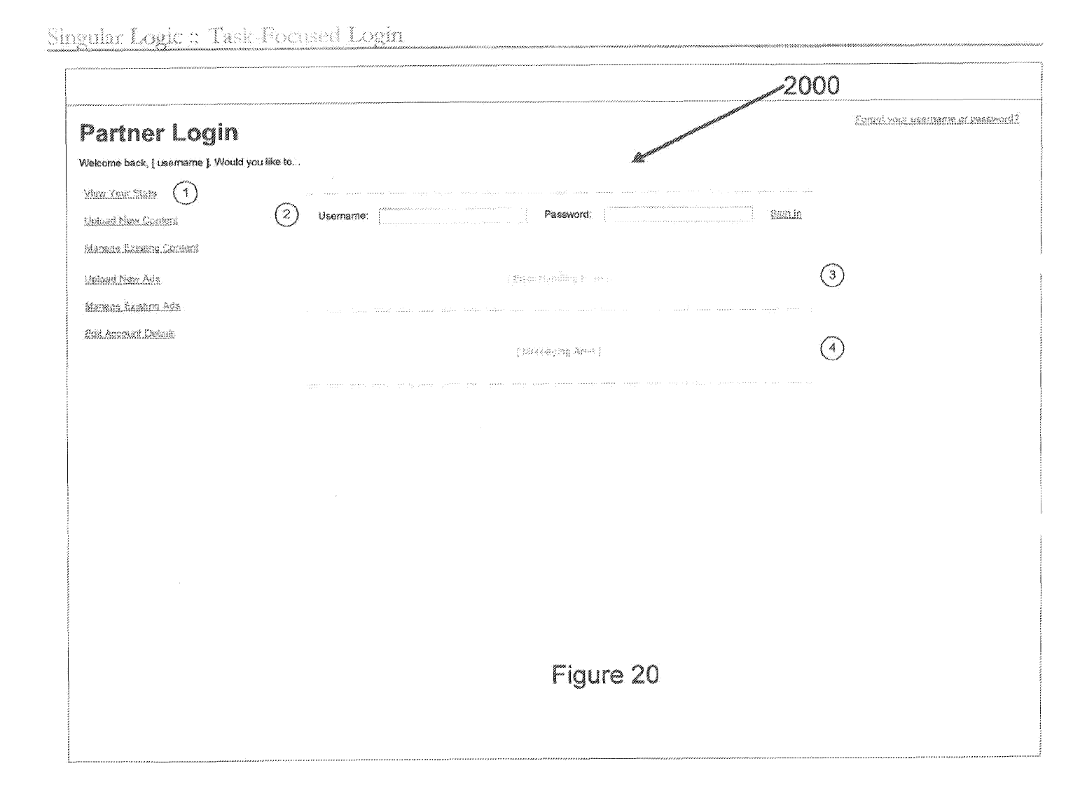

Referring to FIG. 20, an example partner login 2000 is illustrated. Here a partner entity can view their stats, upload new content, manage existing content, upload new ads, manage existing ads, or edit account details.

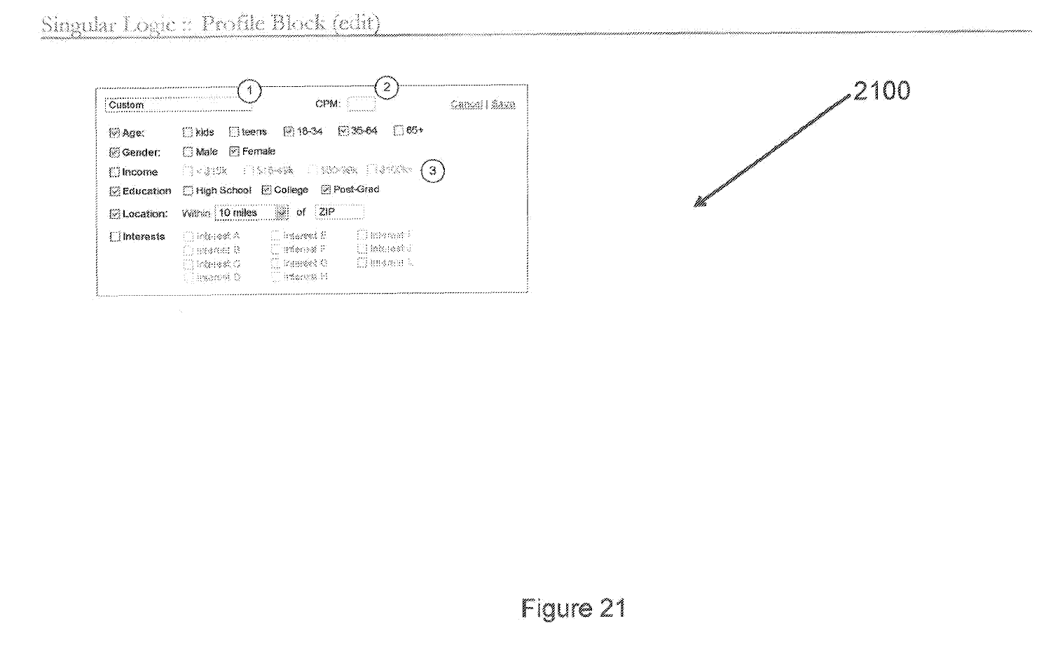

Referring to FIG. 21, an example profile bock 2100 is illustrated. The profile block 2100 allows advertisers to target users for a particular ad, which allows that user to have the ability to choose to view that ad.

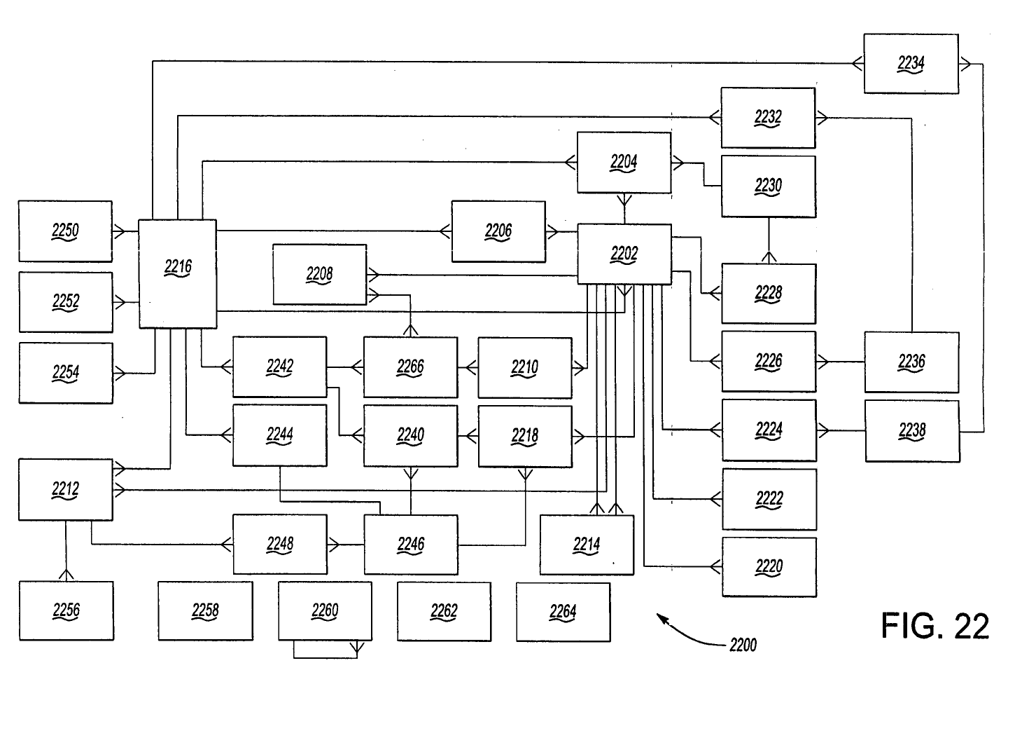

Referring to FIG. 22, an example data schema 2200 is illustrated. The data schema 2200 illustrates one possible method for defining the relationships of the data stored in a relational database management system, such as Microsoft ® SQL Server™. The data schema 2200 represents data tables, data points and data relationships used to store and access ad, content, user, and performance data.

In particular, FIG. 22 shows the following components of the data schema 2200.

Reference number 2202 is:

DisplayItem

| PK | display_item_id | uniqueidentifier |
|---|---|---|
| FK1 | owner_account_id | int |
| | display_item_type_id | tinyint |
| | enabled | bit |
| | deleted | bit |
| | created_dt | datetime |
| | modified_dt | datetime |
| | last_updt_id | varchar(40) |
| | start_date | datetime |
| | end_date | datetime |
| | publish_date | datetime |

Reference numeral 2204 is:

DisplayItemAccountTag

| PK | display_item_account_tag_id | int identify |
|---|---|---|
| FK2, U1 | display_item_id | uniqueidentifier |
| FK1, U1 | account_id | int |
| FK3, U1 | tag_id | int |
| | tag_dt | datetime |
| | created_dt | datetime |
| | modified_dt | datetime |
| | last_updt_id | varchar(40) |

Reference numeral 2206 is:

DisplayItemAccountRating

| PK | display_item_account_rating_id | int identity |
|---|---|---|
| FK2 | display_item_id | uniqueidentifier |
| FK1 | account_id | |
| | is_active | |
| | rating | |
| | rating_date | |
| | created_dt | |
| | modified_dt | |
| | last_updt_id | |

Reference numeral 2208 is:

AccountDisplayItemFavorite

| PK | account_display_item_favorite_id | int identity |
|---|---|---|
| FK2 | display_item_id | uniqueidentifier |
| FK1 | account_id | int |
| | created_dt | datetime |
| | modified_dt | datetime |
| | last_updt_id | varchar(40) |

Reference numeral 2210 is:

ViewEventItemRelated

| PK | view_event_item_related_id | bigint identity |
|---|---|---|
| FK1 | display_item_id | uniqueidentifier |
| | was_clicked | bit |
| | url | varchar(2000) |
| | created_dt | datetime |
| | modified_dt | datetime |
| | last_updt_id | varchar(40) |
| FK2 | view_event_item_id | bigint |

Reference numeral 2212 is:

Profile

| PK | profile_id | uniqueidentifier |
|---|---|---|
| | profile_type_id | tinyint |
| FK1 | owner_account_id | int |
| | profile_name | nvarchar(50) |
| | created_dt | datetime |
| | modified_dt | datetime |
| | last_updt_id | varchar(40) |
| | enabled | bit |
| | deleted | bit |
| FK2 | display_item_id | uniqueidentifier |
| | location_miles | decimal(10.8) |
| | location_zip_code | varchar(10) |

Reference numeral 2214 is:

DisplayItemRelated

| PK | display_item_related_id | int identify |
|---|---|---|
| | created_dt | datetime |
| | modified_dt | datetime |
| | last_updt_id | varchar(40) |
| FK1,U1 | parent_display_item_id | uniqueidentifier |
| FK2,U1 | child_display_item_id | uniqueidentifier |

Reference numeral 2216 is:

Account

| PK | account_id | int identity |
|---|---|---|
| U1 | username | varchar(50) |
| | password | varchar(64) |
| | password_salt | varchar(6) |
| | email_address | varchar(250) |
| | display_name | nvarchar(50) |
| | first_name | nvarchar(50) |
| | middle_name | nvarchar(50) |
| | last_name | nvarchar(50) |
| | failed_logins | int |
| | reset_guid | uniqueidentifier |
| | created_dt | datetime |
| | modified_dt | datetime |
| | last_updt_id | varchar(40) |
| | enabled | bit |
| | deleted | bit |
| U2 | cookie_guid | uniqueidentifier |
| | zip_code | varchar(50) |
| | birth_date | datetime |
| | city | nvarchar(50) |
| | state | nvarchar(50) |

Reference numeral 2218 is:

DisplayItemDemographicTimeStat

| PK | display_item_demogaphic_time_stat_id | bigint identify |
|---|---|---|
| FK2,U1 | display_item_id | uniqueidentifier |
| FK1,U1 | demographic_id | smallint |
| U1 | time_period_type_id | tinyint |
| U1 | begin_dt | datetime |
| | count_views | int |
| | count_clicks | int |
| | sum_cost_per_thousand | decimal(18.8) |
| | sum_rating | int |
| | count_rating | int |
| | created_dt | datetime |
| | modified_dt | datetime |
| | last_updt_id | varchar(40) |

Reference numeral 2220 is:

DisplayItemTimeRatingStat

| PK | display_item_time_rating_stat_id | int identify |
|---|---|---|
| FK1,U1 | display_item_id | uniqueidentifier |
| U1 | time_period_type_id | tinyint |
| U1 | rating | tinyint |
| | count_rating | int |
| | created_dt | datetime |
| | modified_dt | datetime |
| | last_updt_id | varchar(40) |
| U1 | begin_dt | datetime |

Reference numeral 2222 is:

DisplayItemTimeStat

| PK | display_item_time_stat_id | bigint identity |
|---|---|---|
| FK1,U1 | display_item_id | uniqueidentifier |
| U1 | begin_dt | datetime |
| | count_views | int |
| | count_clicks | int |
| | sum_cost_per_thousand | decimal(18.8) |
| | sum_rating | int |
| | count_rating | int |
| | created_dt | datetime |
| | modified_dt | datetime |
| | last_updt_id | varchar(40) |
| U1 | time_period_type_id | tinyint |
| | sum_match_percent | decimal(18.8) |

Reference numeral 2224 is:

DisplayItemContentType

| PK | display_item_content_type_id | int identify |
|---|---|---|
| FK2,U1 | display_item_id | uniqueidentifier |
| FK1,U1 | content_type_id | smallint |
| | created_dt | datetime |
| | modified_dt | datetime |
| | last_updt_id | varchar(40) |

Reference numeral 2226 is:

DisplayItemAdType

| PK | display_item_ad_type_id | int identify |
|---|---|---|
| FK1,U1 | display_item_id | uniqueidentifier |
| FK1,U1 | ad_type_id | smallint |
| | created_dt | datetime |
| | modified_dt | datetime |
| | last_updt_id | varchar(40) |

Reference numeral 2228 is:

DisplayItemTag

| PK | display_item_tag_id | int identify |
|---|---|---|
| FK1,U1 | display_item_id | uniqueidentifier |
| FK2,U1 | tag_id | int |
| | created_dt | datetime |
| | modified_dt | datetime |
| | last_updt_id | varchar(40) |

Reference numeral 2230 is:

Tag

| PK | turgid | int identify |
|---|---|---|
| U1 | tag_name | nvarchar(255) |
| | created_dt | datetime |
| | modified_dt | datetime |
| | last_updt_id | varchar(40) |

Reference numeral 2232 is:

AccountAdType

| PK | account_ad_type_id | int identify |
|---|---|---|
| FK1,U1 | account_id | int |
| FK2,U1 | ad_type_id | smallint |
| | preference_order | int |
| | created_dt | datetime |
| | modified_dt | datetime |
| | last_updt_id | varchar(40) |

Reference numeral 2234 is:

AccountContentType

| PK | account_content_type_id | int identify |
|---|---|---|
| FK1,U1 | account_id | int |
| FK2,U1 | content_type_id | smallint |
| | preference_order | int |
| | created_dt | datetime |
| | modified_dt | datetime |
| | last_updt_id | varchar(40) |

Reference numeral 2236 is:

AdType

| PK | ad_type_id | smallint identity |
|---|---|---|
| | name | nvarchar(50) |
| | created_dt | datetime |
| | modified_dt | datetime |
| | last_updt_id | varchar(40) |
| | enabled | bit |
| | deleted | bit |

Reference numeral 2238 is:

ContentType

| PK | content_type_id | smallint identity |
|---|---|---|
| | name | nvarchar(50) |
| | created_dt | datetime |
| | modified_dt | datetime |
| | last_updt_id | varchar(40) |
| | enabled | bit |
| | deleted | bit |
| | display_order | int |

Reference numeral 2240 is:

ViewEventDemographic

| PK | view_event_demographic_id | bigint identity |
|---|---|---|
| FK2,U1 | view_event_id | bigint |
| FK1,U1 | demographic_id | smallint |
| | created_dt | datetime |
| | modified_dt | datetime |
| | last_updt_id | varchar(40) |

Reference numeral 2242 is:

ViewEvent

| PK | view_event_id | bigint identity |
|---|---|---|
| FK1 | account_id | int |
| | view_dt | datetime |
| | created_dt | datetime |
| | modified_dt | datetime |
| | last_updt_id | varchar(40) |

Reference numeral 2244 is:

AccountDemographic

| PK | account_demographic_id | int identity |
|---|---|---|
| FK1,U2,U1 | account_id | int |
| FK2,U2 | demographic_id | smallint |
| | created_dt | datetime |
| | modified_dt | datetime |
| | last_updt_id | varchar(40) |

Reference numeral 2246 is:

Demographic

| PK | demographic_id | smallint identity |
|---|---|---|
| U1 | demographic_group_id | smallint |
| U1 | name | nvarchar(50 |
| | created_dt | datetime |
| | modified_dt | datetime |
| | last_updt_id | varchar(40) |
| | enabled | bit |
| | deleted | bit |
| | display_order | int |
| | min_value | decimal(18.8) |
| | max_value | decimal(18.8) |

Reference numeral 2248 is:

ProfileDemographic

| PK | profile_demographic_id | int identity |
|---|---|---|
| FK2,U1 | profile_id | uniqueidentifier |
| FK1,U1 | demographic_id | smallint |
| | created_dt | datetime |
| | modified_dt | datetime |
| | last_updt_id | varchar(40) |

Reference numeral 2250 is:

AccountTimeRatingStat

| PK | account_time_rating_stat_id | int identity |
|---|---|---|
| FK1,U1 | account_id | int |
| U1 | time_period_type_id | tinyint |
| U1 | begin_dt | datetime |
| U1 | rating | tinyint |
| | count_rating | int |
| | created_dt | datetime |
| | modified_dt | datetime |
| | last_updt_id | varchar(40) |

Reference numeral 2252 is:

AccountAccountType

| PK | account_account_type_id | int identity |
|---|---|---|
| FK1,U1 | account_id | int |
| U! | account_type_id | tinyint |
| | created_dt | datetime |
| | modified_dt | datetime |
| | last_updt_id | varchar(40) |

Reference numeral 2254 is:

AccountTimeStat

| PK | account_time_stat_id | int identity |
|---|---|---|
| FK1 | account_id | int |
| | time_period_type_id | tinyint |
| | begin_dt | datetime |
| | count_views | int |
| | count_clicks | int |
| | sum_cost_per_thousand | decimal(18.8) |
| | sum_rating | int |
| | count_rating | int |
| | created_dt | datetime |
| | modified_dt | datetime |
| | last_updt_id | varchar(40) |
| | sum_match_percent | decimal(18.8) |

Reference numeral 2256 is:

ProfileBid

| PK | profile_bid_id | int identity |
|---|---|---|
| FK1,U1 | profile_id | uniqueidentifier |
| U1 | percent_match | decimal(18.8) |
| | cost_per_thousand_bid | decimal(18.8) |
| | created_dt | datetime |
| | modified_dt | datetime |
| | last_updt_id | varchar(40) |

Reference numeral 2258 is:

Property

| PK | property_id | int identity |
|---|---|---|
| U1 | object_id | uniqueidentifier |
| U1 | property_type_id | int |
| | object_type_id | tinyint |
| | property_value | ntext |
| | created_dt | datetime |
| | modified_dt | datetime |
| | last_updt_id | varchar(40) |
| | property_date_type_id | int |

Reference numeral 2260 is:

DbFile

| PK | db_file_id | uniqueidentifier |
|---|---|---|
| FK1 | parent_db_file_id | uniqueidentifier |
| | file_data_segment | image |
| | has_child_segment | bit |
| | created_dt | datetime |
| | modified_dt | datetime |
| | last_updt_id | varchar(40) |

Reference numeral 2262 is:

ErrorLog

| PK | error_id | uniqueidentifier |
|---|---|---|
| | error_message | ntext |
| | request_url | nvarchar(1024) |
| | referrer_url | nvarchar(1024) |
| | server_name | varchar(64) |
| | cookie_dump | ntext |
| | created_date | datetime |
| | update_user_id | varchar(40) |

Reference numeral 2264 is:

ReferenceFile

| PK | reference_file_id | uniqueidentifier |
|---|---|---|
| U1 | file_type_id | smallint |
| | file_storage_type_id | tinyint |
| | filesystem_filename | varchar(255) |
| | file_byte_size | int |
| | created_dt | datetime |
| | modified_dt | datetime |
| | last_updt_id | varchar(40) |

Reference numeral 2266 is:

ViewEventItem

| PK | view_event_item_id | bigint identity |
|---|---|---|
| FK2 | view_event_id | bigint |
| FK1 | display_item_id | uniqueidentifier |
| | display_position | smallint |
| | cost_per_thousand | decimal(18.8) |
| | created_dt | datetime |
| | modified_dt | datetime |
| | last_updt_id | varchar(40) |

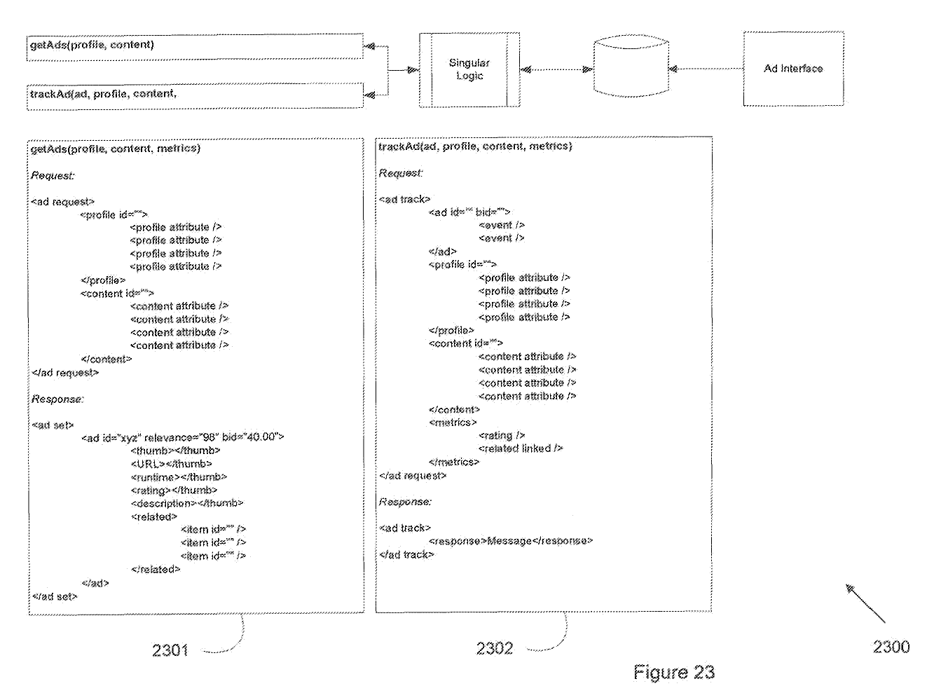

Referring to FIG. 23, an example ad technology accessing model 2300 is illustrated. The model 2300 demonstrates one possible method of communicating ad content to an external system derived from user information provided by the external system and content information provided by the external system. The model also illustrates one possible method of tracking the performance characteristics of that ad as viewed by the user.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of providing feedback regarding advertising on a client computing device having a processor and a memory, the method comprising:
loading content into the client computer memory for display to a user based on a selection by the user;
searching for advertising options to display with the content;
filtering the advertising options for advertising options matching advertising provider preferences;
loading user-stated preferences;
filtering the advertising options matching advertising provider preferences for advertising options corresponding to user-stated preferences;
selecting the at least one of the advertising options corresponding to user-stated preferences;
loading the selected advertising option into the client computer memory for display to the user;
associating the advertising option to the content;
determining performance data based on the content and associated ad; and
providing feedback regarding the performance data;
wherein it can be determined how many times the ad was viewed, who viewed it, a cost for the ad, what content was viewed along with the ad, or how was the ad received by users.

2. The method according to claim 1 wherein determining performance data includes determining performance data on a computing device other than the client computing device.

3. The method according to claim 1, wherein filtering the advertising options for advertising options matching the user-stated preferences includes filtering the advertising options for advertising options corresponding to user-stated preferences on a computing device other than the client computing device and filtering the advertising options corresponding to advertising provider preferences includes filtering the advertising options corresponding to advertising provider preferences in a computing device other than the client computing device.

4. The method according to claim 1, wherein loading user-stated preferences includes loading user-stated preferences previously stated by the user.

5. The method according to claim 1, wherein loading user-stated preferences includes loading user-stated preferences as the user states those preferences.

6. The method according to claim 1, wherein content includes written content, video content, and audio content.

7. A method of providing feedback regarding advertising, the method comprising:
loading content into a viewer for display to a user;
determining at least one advertisement from user-stated preferences;
loading the advertisement into the viewer for display to the user;
associating the advertisement to the content;
determining performance data based on the content and associated advertisement; and
providing feedback regarding the performance data;
wherein it can be determined how many times the advertisement was viewed, who viewed it, a cost for the advertisement, what content was viewed along with the advertisement, or how was the advertisement received by, users.

8. The method according to claim 7, wherein content includes written content, video content, and audio content.

9. The method according to claim 7, further comprising determining at least one advertisement from advertisement provider preferences.

10. The method according to claim 7, wherein the viewer is a web viewer.

11. A method of providing feedback regarding content, the method comprising:
loading content into a viewer for display to a user;
determining at least one advertisement from user stated preferences;
loading the advertisement into the viewer for display to the user;
associating the advertisement to the content;
determining performance data based on the content and associated advertisement; and
providing feedback regarding the performance data;
wherein it can be determined how many time the content was viewed, who viewed it, how much revenue was generated, what advertisements were viewed along with the content, or how was the content received by users.

12. The method according to claim 11, wherein content includes written content, video content, and audio content.

13. The method according to claim 11, further comprising determining at least one advertisement from advertisement provider preferences.

14. The method according to claim 11, wherein the viewer is a web viewer.

15. A method of delivering content and advertising to a consumer, the method comprising:
receiving stated consumer's preferences for content subject matter and advertising subject matter;
selecting one or more of content subject matter and one or more advertising subject matter according to the stated consumer preferences;
transmitting the selected content and advertising subject matter to the consumer for the consumer to choose the content and advertising subject matter to be viewed.
